(19) United States
(12) Patent Application Publication
(10) Pub. No.: US 2015/0264778 A1
(43) Pub. Date: Sep. 17, 2015

(54) CONTROL SYSTEM FOR LOADS WITH A DISTRIBUTED ARRANGEMENT, MORE PARTICULARLY FOR LAMP-OPERATING DEVICES AND METHOD FOR PUTTING THE SYSTEM INTO OPERATION

(71) Applicant: ZUMTOBEL LIGHTING GMBH, Dornbirn (AT)

(72) Inventor: Gregor Mayr, Feldkirch (AT)

(73) Assignee: ZUMTOBEL LIGHTING GMBH, Dornbirn (AT)

(21) Appl. No.: 14/435,162

(22) PCT Filed: Oct. 9, 2013
(86) PCT No.: PCT/EP2013/071045

§ 371 Date: Apr. 11, 2015

(30) Foreign Application Priority Data
Oct. 11, 2012 (DE) 10 2012 218 521.6

(51) Int. Cl. H05B 37/02

(52) U.S. Cl. CPC H05B 37/0227; H05B 37/0272; H05B 37/0254; H05B 37/0218

(57) ABSTRACT

A method for putting into operation a control system for a plurality of loads with a distributed arrangement, particularly for lamp-operating devices, positional information relating to an arrangement and/or position of the load is determined by a sensor unit and the positional information is transmitted by the sensor unit to the load and stored by same.

The present invention relates to a method for commissioning a control system for a plurality of distributed loads, which loads may particularly be lighting control gear. In addition, the invention relates to a method for commissioning such a control system.

Modern and complex buildings have a wide range of means for controlling and monitoring the installations in the building. Not only does this increase convenience for the residents or users when control systems assist in controlling as many as possible of the operating functions to be coordinated, but the design of the building services equipment also impacts on building security, on reliability and on energy and cost efficiency. A wide range of controllable lighting equipment is provided especially in complex buildings such as e.g. hospitals, airports or also other public buildings. Demand for systems that can be adapted flexibly and cost-effectively is inevitable particularly when multifunctional media or automation systems are added to the mix.

The individual loads, for instance the lighting control gear in a sizable lighting system, are controlled using an address which is assigned individually to each load and by means of which the central control unit can operate said loads. In this process, the lighting control gear is preferably assigned what are known as operating addresses, which also take into account, amongst other information, the arrangement of the light sources in the various areas of the building to be illuminated. This assignment often also includes the additional facility to combine the light sources arranged in the various rooms into groups, which can be operated jointly by the central control unit.

Control systems for lighting control gear that enable individual control of the control gear today often work in accordance with the “DALI” standard (Digital Addressable Lighting Interface). This is an interface developed by the lighting industry for transmitting digital control commands between a central control unit and distributed loads. Then up to 64 luminaires or items of control gear, each individually addressable, can be connected to a controller via a DALI bus, as it is known. Since the corresponding items of lighting control gear still do not have an operating address when they are made and installed in the lighting system, this operating address must be allocated as part of an initialization procedure, which must be performed in accordance with the DALI standard as described below.

After installing all the lighting control gear without regard to their spatial arrangement, the items of control gear for the individual luminaires are first connected to the DALI bus, i.e. to the common control line. The subsequent supply of voltage to the lighting control gear causes each item of lighting control gear to generate by itself an individual random address. The command for the lighting control gear to report with their random address is then issued from the central controller, whereby, in accordance with special algorithms, a list of all the control gear is created internally in the controller and also includes the information about which random addresses or original addresses can be used to contact each item of gear.

Since, however, this random address does not yet take account of the spatial arrangement of the lighting control gear, the operating address intended for subsequent operation is then assigned to each item of gear in a subsequent step. This is done by the central controller initially invoking a first random address, which results in the corresponding luminaire identifying itself, so for instance switching on its light. Now a person must establish in which room this luminaire is located. Once the position has been established, a suitable response is made to the control center. A further person then enters the location and group of the reporting luminaire in the controller, with the result that this luminaire is then assigned an appropriate operating address, i.e. an operating address that takes into account the position of the luminaire. All the random addresses are dealt with one after the other in this manner until all the luminaires have been assigned an operating address. Each operating address is saved in a corresponding memory of the particular item of lighting control gear and obviously also stored in the central control unit.

EP 0 766 881 A1 and EP 0 433 527 A1 disclose comparable procedures for assigning operating addresses to lighting control gear in sizable lighting systems. All these known methods are based on the principle that the lighting control gear is initially invoked for the purpose of identification by an original or random address that does not take the position into account, and after establishing the actual position of the luminaire, a new operating address is then assigned to this luminaire.

The disadvantage with these solutions known from the prior art is thus in particular that although the individual loads are able to identify themselves with the central controller by means of their original or random address in such a way that individual communication between controller and load is possible, the position of each load must still be determined in a separate step in order to assign a meaningful operating address.

Therefore the object of the present invention is to define a novel way of commissioning such a control system that is simpler and quicker to perform.

The object is achieved by a method for commissioning a control system, which method has the features of claim 1. In addition, the present invention also relates to a corresponding control system according to claim 10. A sensor unit as claimed in claim 17 is also proposed according to the invention. The subject matter of the dependent claims contains advantageous developments of the invention.

The solution according to the invention provides that a sensor unit is used to determine position information reflecting the position or arrangement of a load, and the sensor unit then transmits this position information to the load, which stores said position information.

Thus a method for commissioning a control system for a plurality of distributed loads, in particular for lighting control gear, is proposed according to the invention, in which method a sensor unit is used to determine position information relating to the position or spatial arrangement of the load, and the sensor unit transmits the position information to the load, which stores said position information. For this purpose, the sensor unit is preferably placed close to the relevant load, and the position of the sensor unit is determined as the position information.

By each load saving information relating to its position in accordance with the invention, the procedure for assigning the operating addresses can be made dramatically simpler and faster, while still being able to resort largely to the methods provided until now for commissioning the system. Thus it can be provided also in the method or system according to the present invention that all the loads report to a central controller under an individual original or random address. It can now be provided, however, that as part of this identification with the controller, the relevant position information is also transmitted. In this process, either each load can transmit the position information after contact is made by the controller by means of the original or random address and relevant request made, or as early as when the original or random address is first transmitted. It would even be possible for the position information itself to constitute the original address, because the loads normally have different positions and hence it should be possible to use this position information to distinguish between the loads uniquely. Irrespective of how the position information is transmitted, the controller is then still able to contact each load and moreover also has knowledge of its position. Based on this position information, it is then possible to create and assign to the loads operating addresses, preferably automated operating addresses. The intermediate step required in the solutions from the prior art, namely to determine the position of each individual load after the central controller has requested said load to output a visual signal, can hence be dispensed with here.

The fact that position information on the loads connected to the system is immediately available to the central controller can also be used for more convenient control of the system overall. Thus, for instance, the controller can be designed to provide on the basis of the position information, a graphical representation of the arrangement of the loads. In solutions previously known from the prior art, even this was possible to implement only in an extremely complex manner, or the relevant information had to be provided manually to the system. In comparison, the controller can now immediately present an arrangement of the luminaires. If this representation is combined with additional information, e.g. building plans, regarding the design of the building, an extremely clear and realistic representation can actually be obtained that further substantially improves the ease of use of the system.

Another advantageous development of the invention results in that, for the case in which the loads are lighting control gear, the control of the lighting control gear can be optimized in terms of taking account of the daylight. In this case, daylight information is also determined jointly with the position information preferably again by the sensor unit. This daylight information indicates in what way, for instance, the light entering through a window affects the light level in the area to be illuminated by the corresponding luminaire. This daylight information can then once again be transmitted to the lighting control gear, wherein during subsequent operation of the system, either the lighting control gear takes into account this daylight information in implementing received commands, or this daylight information is already taken into account in generating commands transmitted to the lighting control gear. In this case, the extent of the effect of the daylight on the area to be illuminated can thus be taken into account individually for each individual luminaire. The light output taking into account the daylight can be optimally taken into account in this case in particular without corresponding control systems and the associated use of a multiplicity of light-level sensors, which is also highly advantageous in particular with regard to energy saving by the lighting system.

The position information and, if applicable, the daylight information can be transmitted to the load in each case in particular wirelessly, preferably by what is known as near-field communication. If applicable, however, a temporary connection using a cable between the load and the sensor unit would also be possible. Wireless information transmission is nonetheless obviously advantageous particularly when the luminaires, or generally the loads, are only accessible with difficulty, for example are arranged on the ceiling of relatively high rooms or halls.

The sensor unit itself should be capable of being able to determine the position as exactly as possible. This does not present a problem in the first instance if the load is outside enclosed spaces, and hence GPS can be used for determining the position. Since the method according to the invention, however, is intended to be applicable in particular also to lighting systems for lighting of buildings or the like, the sensor unit should also be able to determine the positions of the loads inside a building. Such technologies are already available, however, and then involve using a wide range of sensors, for instance acceleration sensors, pressure sensors, gyroscopes and the like. Finally, the sensor unit must therefore then be positioned suitably close to the load in order to determine the position of the load and then transfer the information to the load.

The invention shall be explained in more detail below with reference to the accompanying drawing, in which:

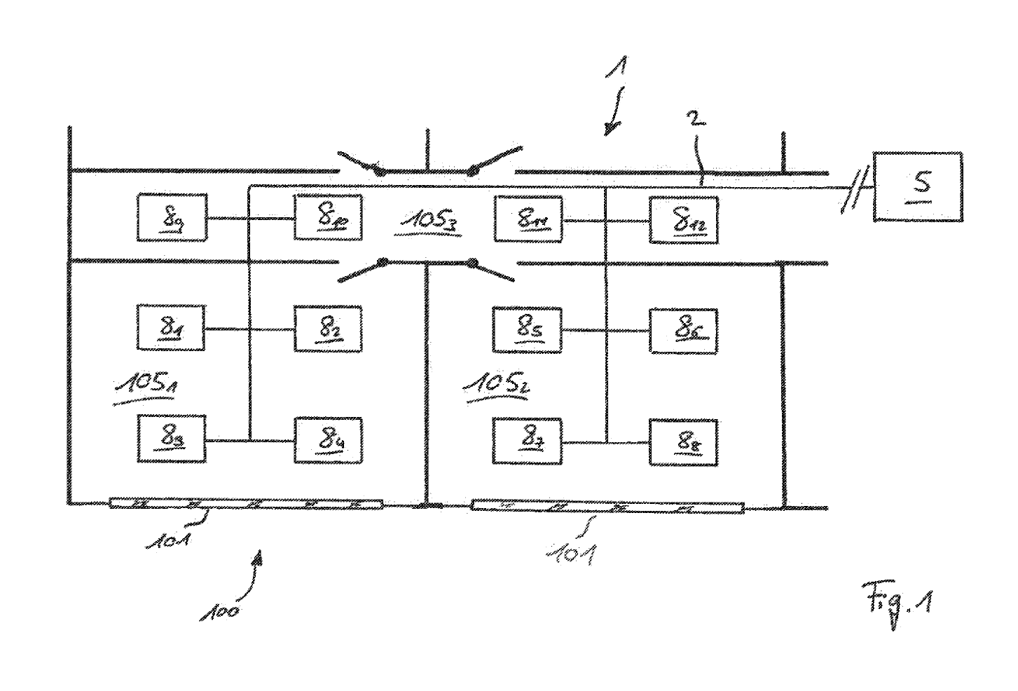

FIG. 1 shows a segment of a lighting system embodied according to the invention;

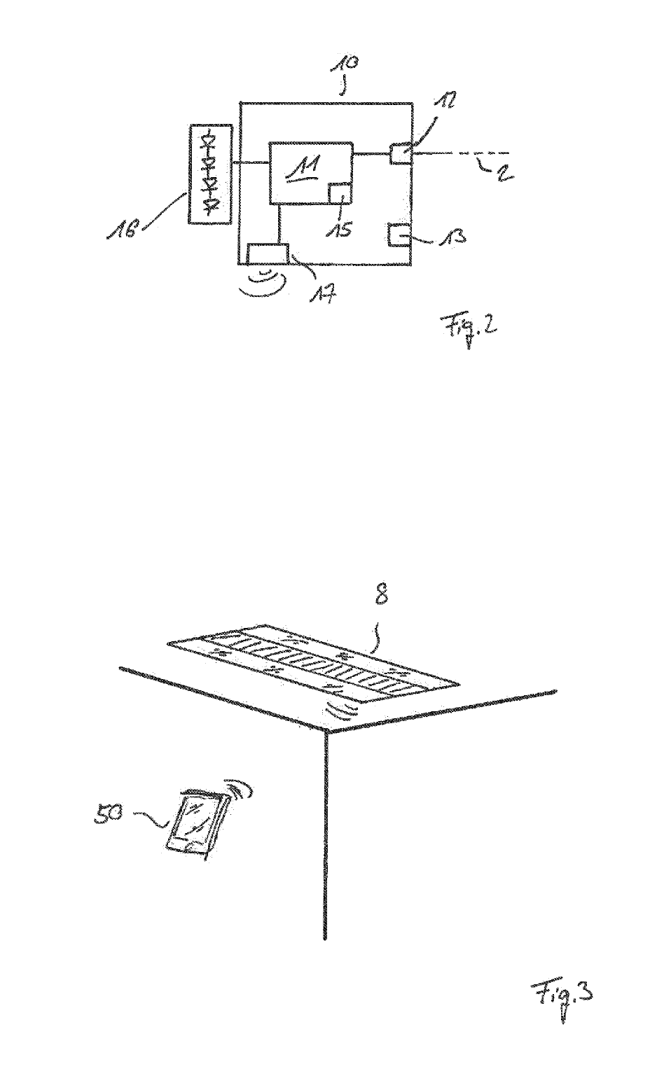

FIG. 2 shows schematically the embodiment of a load in the lighting system;

FIG. 3 shows the procedure for determining the position of a load; and

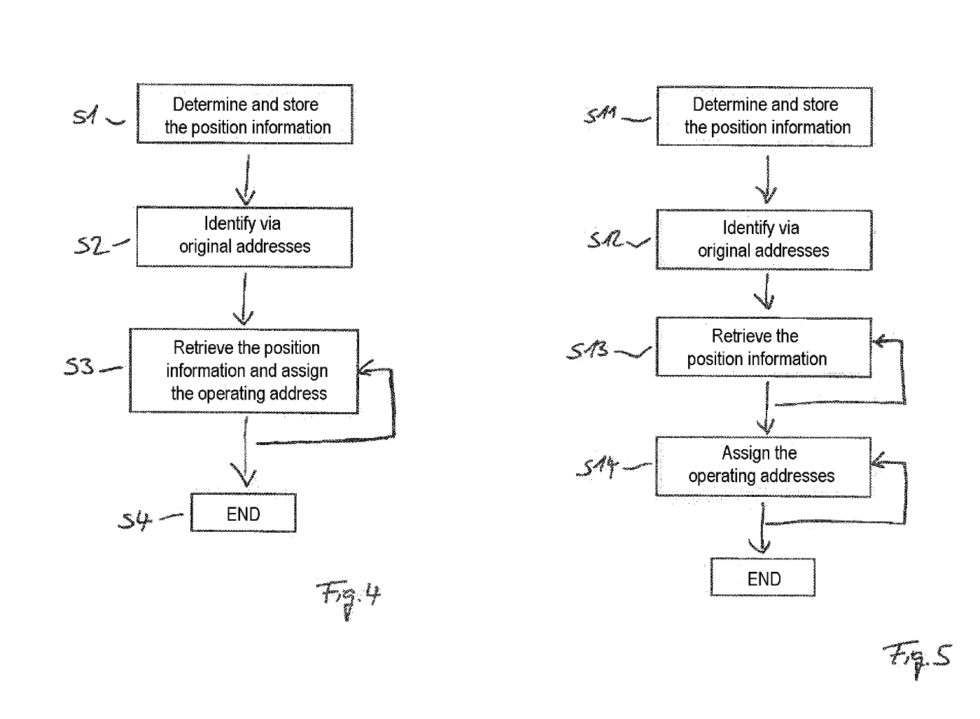

FIGS. 4 and 5 show two variants of a method according to the invention for allocating operating addresses.

The invention shall be explained below using the example of a sizable lighting system for lighting a building. It should be mentioned, however, that the invention is in no way limited to control systems for lighting control gear or luminaires. For instance, the solution according to the invention could be used generally in building automation systems intended for remote control of a wide range of equipment. The term loads therefore includes, for example, also blinds, heating, ventilation and air-conditioning units and/or monitoring equipment in addition to lighting control gear.

As an example application of the method according to the invention, FIG. 1 shows part of a building 100 in which a lighting system 1 is thus used that comprises a plurality of luminaires 8₁-8₁₂, which are distributed in different rooms of the building 100. In particular, the depicted segment of the building 100 shows two rooms 105₁ and 105₂, in each of which are arranged four luminaires 8₁-8₄ and 8₅-8₈ respectively. The two rooms 105₁ and 105₂ are connected to each other via a corridor 105₃, along which lighting is likewise meant to be implemented, in this case using four further luminaires 8₉-8₁₂ depicted. All the luminaires 8₁-8₁₂ are connected to a central control unit 5 via a common bus system 2, it being assumed in the present case that communication takes place in accordance with the DALI standard via the bus system 2 between the central controller 5 and the luminaires 8₁-8₁₂, more precisely between the controller 5 and the control gear of the luminaires 8₁-8₁₂. Having said this, any other type of communication could obviously also be provided as long as there is the facility to use appropriate addresses to allow individual data transfer between the central controller 5 and the individual luminaires 8₁-8₁₂. The present example application does not show the additional lines for supplying power to the luminaires 8₁-8₁₂, where it would obviously also be possible to perform the data transfer between the central controller 5 and the luminaires 8₁-8₁₂ via the electricity supply network itself in the context of Powerline Communication as it is known.

As in the lighting systems on which the present invention is based, also in this case the individual items of control gear of the luminaires 8₁-8₁₂ are assigned operating addresses, via which, during subsequent operation of the system 1, these items of control gear can receive commands, which are used, for instance, to adjust the light level or to switch on or off the luminaires 8₁-8₁₂ generally. Each load or each item of lighting control gear 10 hence comprises a control unit 11, as shown in the diagram of FIG. 2, which is connected to a transceiver or an interface 12, via which a connection is made to the bus line 2 and data is exchanged. Corresponding address information is stored in a memory 15 of the control unit 11 or of the lighting control gear 10 so that the load 10 can identify whether or not it is the intended recipient of a control signal arriving on the bus line 2. Arriving commands are then suitably processed in the control unit 11. This means in particular that the supply voltage provided via the power supply terminal 13 is converted into a suitable current for operating the light source 16, in this case implemented in the form of a plurality of LEDs. The operating address stored in the memory 15 of the load 10 takes into account here in particular also the position of the load 10 inside the building 1 in order to facilitate efficient and clear control of the luminaires 8₁-8₁₂. In particular, this operating address can also include a definition of a group association, for instance in order to control all the luminaires inside a room in common.

Until now, the operating address was assigned, as described in the introduction, for example by all the loads identifying themselves with the central controller by means of an individual original address in a first step. Then the loads were requested one after the other to output a visual signal, with suitable personnel then having to establish the position in which the luminaire currently identifying itself is located, in order to commission the system. This information then had to be fed back to the control center and was taken into account in assigning the appropriate operating address to this luminaire.

This relatively complicated procedure can be simplified considerably by the solution according to the invention. As shown in the diagram in FIG. 3, the idea here according to the invention consists in determining in advance the position of the load, so in this case of the luminaire 8 or of the lighting control gear 10, and saving this position in the memory 15 of the lighting control gear 10. The position information can then be transmitted directly to the central controller and taken into account in assigning the operating address. The laborious process of locating a luminaire currently emitting a visual signal can hence be dispensed with in this case.

FIG. 3 shows by way of example a luminaire 8 located on the ceiling of a room, the position of which luminaire is determined using a sensor unit 50 according to the invention. This sensor unit 50 is positioned close to the luminaire 8 for this purpose, and is able to communicate wirelessly with the control gear 10 of the luminaire 8. A connection according to the Bluetooth standard, for example, would be possible, preferably using “near-field communication” (NFC). This means that when the sensor unit 50 is placed suitably close to the luminaire 8, a connection between both units is set up directly irrespective of whether or not additional luminaires are located in the room. According to the diagram of FIG. 2, an item of lighting control gear 10 embodied according to the invention hence comprises additional means 17 for wireless communication.

The sensor unit 50 is preferably implemented as a portable device, e.g. as a smartphone, and must be capable of being able to determine the position of the luminaire 8 as accurately as possible. To be precise, the sensor unit 50 determines its own position and then transmits this position to the luminaire 8 or lighting control gear 10, which is why the sensor unit 50 should be placed sufficiently close to the luminaire 8 and preferably in each case in a defined orientation or direction with respect to the luminaire. Hence the sensor unit 50 must be capable of being able to determine the position as accurately as possible. This does not present a problem in the first instance if the sensor unit 50 is arranged outside enclosed buildings, because in this case GPS can be used for determining the position, for example. For the primary application of usage inside rooms or buildings, however, further sensors must additionally be used, by means of which the position can be determined. In this case it is known from the prior art in particular to use in addition to the GPS information also the information from further sensors, particularly acceleration sensors, pressure sensors, gyroscopes and the like. Such means are already known from the prior art and can be used accordingly here.

A method for allocating operating addresses to luminaires in a sizable lighting system, which method is modified according to the present invention, could then proceed according to the diagram in FIG. 4 as follows:

In a first step S1, the position of each load is determined using the sensor unit and stored in the memory of the load. As already mentioned, this is preferably done by the sensor unit being positioned in the immediate vicinity of each luminaire, and transmitting the then detected position wirelessly by means of near-field communication to the luminaire or the lighting control gear thereof, which then stores this information in the memory.

In a subsequent step S2, the central controller requests all the loads in the system to identify themselves, as was also previously the case. In accordance with various algorithms known from the prior art, the items of lighting control gear then transmit their original or random addresses to the central controller, with the result that the central controller has internally a complete list of all the connected loads together with their original or random addresses, and is hence able to contact each item of lighting control gear individually.

In the next step S3, the central controller then uses the original or random addresses that it has available to contact an individual load, and requests this load to transmit the position information stored in said load. The controller then allocates an operating address on the basis of this position information, and transmits this address to the load, which likewise stores this address for subsequent operation. This operating address takes into account in particular the position of the luminaire inside the building, and can, for example, also include a group association in order subsequently to facilitate logical control of the individual luminaires. This step S3 is repeated until each load has been assigned an operating address. Once this is done, the system is operational, i.e. the luminaires can now be contacted and controlled under the operating addresses assigned to them.

The description of the method shows that in this case the operating addresses can be allocated extremely simply and efficiently. In particular, it is no longer necessary to look for a luminaire contacted individually via the original address and identifying itself by a visual signal, and to notify the central controller of the position of this luminaire. The method according to the present invention therefore leads far more quickly to the intended outcome, namely assigning meaningful operating addresses to the luminaires.

FIG. 5 shows an alternative variant of the method according to the invention shown in FIG. 4, in which again in this case in a first step S11, as also in the step Si, the positions of the luminaires or loads are determined and stored in the memories of same. The subsequent step S12, in which all the loads report to the central controller via their original or random addresses, is also identical to the step S2 described above.

In the next step S13, the loads are again contacted individually via their original or random addresses, and their position information retrieved by the central controller. In this case, however, the operating address is not allocated directly. Instead, the positions of all the loads are first retrieved until the central controller has all the information. Not until a subsequent step S14 are operating addresses then defined on the basis of this position information, and transmitted individually to all the loads, thereby bringing the method to an end.

The advantage of this second variant is that the positions of all the luminaires are determined first and hence are known to the central controller before allocation of the actual operating addresses. This full set of information about the arrangements of the luminaires inside the building may in some circumstances result in a more meaningful allocation of operating addresses because it is immediately identifiable which luminaires are located close to one another and hence should be assigned, for example, to a common group. In this connection, it would also be possible that after the central controller has collected all the position information, a graphical representation of the arrangement of the luminaires in the building is first made, and then a human user is assisted by this graphic representation to group the luminaires and define operating addresses. Similarly, however, the operating addresses could also be defined directly automatically by the controller on the basis of the position information.

As a further variant of the method in FIG. 5, it would also be possible to combine the steps S12 and S13. Thus in this case, during identification, the loads could send to the central controller not only the original or random addresses but also simultaneously the position information. It would even be possible for the position information itself to constitute the original address, provided it is guaranteed that two loads do not have an identical position.

A particular development of the solution according to the invention arises in particular when, as in the exemplary embodiment of FIG. 1, the loads are lighting control gear. (Energy-)efficient control of a lighting system should in this case also always take into account the effect of the light entering the building through windows. In the example of FIG. 1, in which window fronts 101 are shown for the rooms 105₁ and 105₂, the effect of the daylight should obviously have a stronger impact on the front luminaires 8₃, 8₄, 8₇ and 8₈ than on the luminaires 8₁, 8₂, 8₅ and 8₆ farther from the windows 101. That is to say, if the rooms 105₁ and 105₂ are meant to be illuminated at a specific light level, then owing to the effect of the daylight, the luminaires located closer to the windows 101 can be operated at a lower light level than the luminaires arranged farther away from the windows.

For such “daylight control”, a “daylight measurement”, in which the effect of the outside light is measured, is performed according to the current prior art for each floor, façade and luminaire row. The luminaires, after being assigned their operating addresses, are then assigned “daylight factors” according to these measurements. The actual control value for operating the luminaire is then determined in combination with the values from a “daylight sensor” located outside the building.

According to the particularly preferred development of the invention, the sensor unit 50 used to determine the positions of the luminaires or generally of the loads is now used preferably again also to acquire daylight measured values for each position. This means that the sensor unit 50 comprises in addition to the sensors for position determination also means for daylight measurement. The daylight measured value determined jointly with each item of position information is then once again determined by means of near-field communication or via a cable to the associated lighting control gear, and stored there.

The daylight information assigned individually to each luminaire can then be taken into account during subsequent operation of the lighting system. This can be done by the associated item of control gear itself determining the abovementioned daylight factor on the basis of this daylight information, and, if applicable also taking into account the information from the daylight sensor, implementing incoming control commands accordingly, i.e. implementing suitable control values, in order to control the associated light source. Alternatively, the lighting control gear could transmit to the control center also the daylight information jointly with the position information. The control center can then already take this daylight information into account when transmitting appropriate control commands to the lighting control gear. Transmitting the daylight information to the control center is advantageous here in that this can in turn be included with the lighting system in the abovementioned graphical representation of the building. Thus not only the positions of the individual luminaires but also the effect of the daylight on each luminaire can be shown. At the same time, this development also results in optimization of the daylight control compared with previously known solutions, because now daylight information is no longer just determined only as an average for individual luminaire rows but the effect of the outside light is taken into account individually for each luminaire.

Finally, a sizable control system can hence be commissioned far more efficiently and simply using the method according to the invention. The invention is also not necessarily limited to control systems for loads arranged inside buildings. The method could also be used in the same way for loads located outside buildings, for example for luminaires for street-lighting or the like. Moreover, the invention is also not limited to systems in which the loads are connected to the central controller via a bus line or control line, but could also be used, for instance, when communication between the nodes of the system is performed wirelessly, e.g. by radio or using infrared signals.

1. A method for commissioning a control system for a plurality of distributed loads, in particular for lighting control gear, wherein a sensor unit is used to determine position information relating to the arrangement or position of the load, and the sensor unit transmits the position information to the load, which stores said position information.

2. The method as claimed in claim 1, wherein in order to determine the position information, the sensor unit is positioned close to the relevant load, and the position of the sensor unit is determined.

3. The method as claimed in claim 1, wherein the loads are connected to a central controller and are designed to identify themselves to the controller by means of an individual original or random address.

4. The method as claimed in claim 3, wherein the central controller requests as part of an initialization of the system the loads to identify themselves by means of their corresponding original or random address, wherein the original or random address contains at least in part the position information stored in the load, or the loads transmit the position information jointly with their original or random address, or the loads, after transmitting the original or random address, transmit the position information when contact is subsequently made by the controller by means of the original or random address.

5. The method as claimed in claim 4, wherein the central controller assigns operating addresses to the loads on the basis of the position information.

6. The method as claimed in claim 4, wherein the controller is designed to provide, on the basis of the collected position information, a graphical representation of the arrangement of the loads.

7. The method as claimed in claim 1, wherein the position information is transmitted wirelessly to the loads.

8. The method as claimed in claim 1, wherein the position information is transmitted to the load using a cable.

9. The method as claimed in claim 1, wherein the loads are lighting control gear, and daylight information is determined jointly with the position information, preferably likewise by the sensor unit, and transmitted to the lighting control gear, wherein during operation of the system the lighting control gear takes into account the daylight information in implementing received commands, or the daylight information is taken into account in generating commands transmitted to the lighting control gear.

10. A control system for a plurality of distributed loads, in particular for lighting control gear, which control system has at least one controller, which is preferably connected to each load via a control line, wherein the loads are designed to receive and to store information relating to the position of the particular load and determined by a separate sensor unit, and to transmit the position information to the controller.

11. The control system as claimed in claim 10, wherein the central controller as part of an initialization of the system is designed to request the loads to identify themselves by means of a corresponding original or random address, wherein the original or random address contains at least in part the position information stored in the load, or the loads are designed to transmit the position information jointly with their original or random address, or the loads are designed to transmit, after transmitting the original or random address, the position information when contact is subsequently made by the controller by means of the original or random address.

12. The system as claimed in claim 11, wherein the central controller is designed to assign operating addresses to the loads on the basis of the position information.

13. The system as claimed in claim 11, wherein the controller is designed to provide, on the basis of the collected position information, a graphical representation of the arrangement of the loads.

14. The system as claimed in claim 10, wherein the position information is transmitted wirelessly to the loads.

15. The system as claimed in claim 10, wherein the position information is transmitted to the load using a cable.

16. The system as claimed in claim 10, wherein the loads are lighting control gear and are designed to receive and to store daylight information determined jointly with the position information, wherein during operation of the system the lighting control gear takes into account the daylight information in implementing received commands, or the daylight information is taken into account in generating commands transmitted to the lighting control gear.

17. The sensor unit for use in a system as claimed in claim 10, wherein the sensor unit is designed to determine position information relating to the arrangement or position of a load, and to transmit said position information to the load.

18. The sensor unit as claimed in claim 17, wherein the sensor unit also comprises means for acquiring daylight information and for transmitting this daylight information to the load.
